(19) United States
(12) Patent Application Publication
(10) Pub. No.: US 2024/0255713 A1
(43) Pub. Date: Aug. 1, 2024

(54) ADAPTER TIP AND MICROSCOPE SYSTEM FOR INSPECTING APC TRANS-DUPLEX FIBER-OPTIC CONNECTORS

(71) Applicant: EXFO Inc., Quebec (CA)

(72) Inventors: Olivier COTE, Quebec (CA); Jean Filion, Quebec (CA); Raphael LABERGE, Quebec (CA)

(21) Appl. No.: 18/420,965

(22) Filed: Jan. 24, 2024

Related U.S. Application Data
(60) Provisional application No. 63/482,392, filed on Jan. 31, 2023.
(60) Provisional application No. 63/498,952, filed on Apr. 28, 2023.

(51) Int. Cl. G02B 6/38

(52) U.S. Cl. CPC G02B 6/3898; G02B 6/3825; G02B 6/385

(57) ABSTRACT

There is provided an adapter tip to be employed with an optical-fiber connector-endface inspection microscope device and an optical-fiber connector endface inspection microscope system suitable for imaging two non-parallel APC optical-fiber endfaces of a duplex (i.e., APC trans-duplex) optical-fiber connector. Because the two optical-fiber endfaces of an APC trans-duplex connector are angled-polished (APC) in different directions (non-parallel), inspection light reflected on the two endfaces take diverging pathways. A single-fiber or multi-fiber inspection microscope therefore cannot allow inspection of both optical-fiber endfaces at once. The proposed adapter tip or microscope system comprises relay optics defining two imaging paths (one for each optical-fiber endface), wherein each imaging path comprises at least one optical component (e.g., an optical prism) used to deviate inspection light from each endface towards the optical axis of the objective lens, such that both endfaces may be imaged within the field of view of the inspection microscope.

### TECHNICAL FIELD

The present description generally relates to inspection of optical-fiber connector endfaces and more specifically to adapter tips, to be used in conjunction with an optical-fiber connector endface inspection microscope device and suitable for imaging two non-parallel angled-polished optical-fiber endfaces of a duplex optical-fiber connector.

### BACKGROUND

The quality and cleanliness of endfaces of optical-fiber connectors represent important factors for achieving adequate system performance of optical communication networks. Indeed, any contamination of or damage on the mating surface of an optical-fiber connector may severely degrade signal integrity. Optical-fiber inspection microscopes are commonly employed to visually inspect and/or to analyze the optical-fiber endface of an optical-fiber connector at installation or during maintenance of optical communication networks, in order to verify the quality of the optical-fiber connection.

Because of the wide variety of optical-fiber connector types deployed in the telecommunication industry, optical-fiber connector endface inspection microscopes are typically employed with interchangeable adapter tips so as to allow inspection of various types of optical-fiber connectors directly or as inserted in an optical-fiber connector adapter. Optical-fiber connector endface inspection microscopes are therefore typically designed for use with an adapter tip selected among a plurality of adapter tip types.

Optical-fiber connectors to be inspected can be single-fiber, multi-fiber (8 fibers or more) or duplex, and the inspected connector endface may be either non-angled polished (UPC connectors) or angled-polished (APC connectors), i.e., polished at an 8-degree angle respective to the optical fiber axis. Some inspection microscopes allow to inspect all these varieties of connectors by simply changing the adapter tip.

Conventional methods for inspecting APC connectors include tilting the inspection microscope at an 8-degree angle relative to the optical fiber axis in order to illuminate the connector endface in a direction normal to the angled-polished endface.

However, APC connectors are often installed in very dense environments, and it may therefore be impossible to insert the inspection microscope device at angle without disconnecting neighbor optical fibers. Disconnecting represents a huge disadvantage because a disconnected fiber has an increased chance of dust contamination or being scratched. To solve this problem, some single-fiber adapter tips exist (see, e.g., U.S. Pat. No. 9,880,359B2) which comprise an arrangement of lenses which serves to deviate the reflected light beam and to inspect the APC connector without having to tilt the inspection microscope device relative to the optical fiber and connector.

In other solutions (see, e.g., US20220035104A1), a rhomboid can be used to keep lenses as close as possible to the optical axis of the inspection microscope.

More recently introduced APC duplex connectors raise additional issues not addressed by the prior art adapter tips, i.e., the MDC-APC connector is an APC trans-duplex connector which means that its two optical-fiber endfaces are angled-polished (APC), but in different directions (see FIGS. 1A and 1B) (i.e., non-parallel). The above-described prior designs can only inspect one fiber at a time and cannot be used to image both endfaces of an APC trans-duplex connector in a single connection.

There therefore remains a need a solution allowing to inspect two non-parallel angled-polished optical-fiber endfaces of a duplex optical-fiber connector with a single connection to the optical-fiber connector endface inspection microscope.

### SUMMARY

There is provided an adapter tip to be employed with an optical-fiber connector-endface inspection microscope device and an optical-fiber connector endface inspection microscope system suitable for imaging two non-parallel APC optical-fiber endfaces of a duplex (i.e., APC trans-duplex) optical-fiber connector (recessed or not in a duplex connector adapter, sometimes also referred to as a bulkhead). Because the two optical-fiber endfaces of an APC trans-duplex connector are angled-polished (APC) in different directions (non-parallel), inspection light reflected on the two endfaces take diverging pathways. A single-fiber or multi-fiber inspection microscope therefore cannot allow inspection of both optical-fiber endfaces at once. The proposed adapter tip or microscope system comprises relay optics defining two imaging paths (one for each optical-fiber endface), wherein each imaging path comprises at least one optical component (e.g., parallelepiped-like optical prism) used to realign inspection light from each endface towards the optical fiber axis and bring both inspection paths substantially parallel toward the objective lens of the optical-fiber connector-endface inspection microscope device, while they would otherwise take diverging pathways, such that both endfaces may be imaged within the field of view of the inspection microscope.

In the inspection microscope, the two endfaces can be imaged on the same image sensor (e.g., using a single-fiber or multi-fiber inspection microscope) or using two image sensors (e.g., as sometimes used in the art in multi-fiber inspection microscopes in order to obtain a wider field of view necessary for multi-fiber connector inspection).

It is noted that even though the two optical fiber endfaces are imaged concurrently, there may be a slight discrepancy in the optical path lengths corresponding to the two optical fiber endfaces. For that reason, the two endfaces as images concurrently may not be simultaneously in focus on said image sensor(s). Capturing a single image to cover both endfaces may therefore be unsuccessful or imperfect in some cases. This can be solved by capturing a first image while the focus is adjusted so one optical-fiber endface is in focus and capturing a second image while the focus is adjusted so the other optical-fiber endface is in focus. The first and the second images may then be used to characterize the first optical-fiber endface and the second optical-fiber endface, respectively.

In accordance with one aspect, there is provided an adapter tip to be employed with an optical-fiber connector endface inspection microscope for imaging two non-parallel APC optical-fiber endfaces of a duplex optical-fiber connector, the adapter tip comprising:
a housing having:
   a mating interface on one end, configured to mechanically engage with the duplex optical-fiber connector for inspecting the optical-fiber endfaces;
   a connection mechanism on the other end, to releasably attach to the inspection microscope; and
   a hollow body extending between the one end and the other end and allowing light beams reflected from the optical fiber endfaces to propagate to the objective lens of the inspection microscope; and
relay optics disposed in said hollow body of said housing and defining two imaging paths for respectively imaging said two optical-fiber endfaces, said relay optics comprising a first refracting plane surface and a second refracting plane surface along each of said imaging paths, wherein said first refracting plane surface and said second refracting plane surface are both tilted relative to the corresponding light beam so as to deviate said corresponding light beam towards the optical axis of the objective lens, such that both light beams reach the objective lens of the inspection microscope and both endfaces may be imaged within the field of view of the inspection microscope.

In accordance with another aspect, there is provided an optical-fiber connector endface inspection microscope system for imaging two optical-fiber endfaces of a duplex optical-fiber connector, the microscope system comprising:
an optical-fiber connector endface inspection microscope device having an objective lens defining a field of view of the microscope device; and
an adapter tip connectable to the optical-fiber connector endface inspection microscope device and comprising:
   a housing having:
      a mating interface on one end, configured to mechanically engage with the duplex optical-fiber connector for inspecting the optical-fiber endfaces;
      a connection mechanism on the other end, to releasably attach to the inspection microscope; and
      a hollow body extending between the one end and the other end and allowing light beams reflected from the optical fiber endfaces to propagate to the objective lens of the inspection microscope; and
   relay optics disposed in said hollow body of said housing and defining two imaging paths for respectively imaging said two optical-fiber endfaces, said relay optics comprising a first refracting plane surface and a second refracting plane surface along each of said imaging paths, wherein said first refracting plane surface and said second refracting plane surface are both tilted relative to the corresponding light beam so as to deviate said corresponding light beam towards the optical axis of the objective lens, such that both light beams reach the objective lens of the inspection microscope and both endfaces may be imaged within the field of view of the inspection microscope.

In some embodiments, the said relay optics comprise two optical prisms, each along one of said imaging paths such that each optical prism defines a first refracting plane surface and a second refracting plane surface.

The optical prisms may be joint to one another. They may further each comprise longitudinal surfaces and be jointly affixed in the housing by inserting and affixing the optical prisms in the housing such that the longitudinal surfaces abut internal surfaces machined in the housing.

In other embodiments, the said relay optics comprise a first optical wedge and a second optical wedge along each imaging path such that one surface of the first optical wedge defines the first refracting plane surface, and one surface of the second optical wedge defines the second refracting plane surface along each imaging path.

Compared to other prior art solutions, the optical prism approach allows to keep optical axes of the relay optics and the objective lens parallel to the optical fiber axis, as well as keeping all components compact transversally by minimizing lateral shifts. The optical prism components also advantageously make mechanical assembly easy and less complex compared to the two-wedge solution.

In this specification, unless otherwise mentioned, word modifiers such as “substantially” and “about” which modify a value, condition, relationship or characteristic of a feature or features of an embodiment, should be understood to mean that the value, condition, relationship or characteristic is defined to within tolerances that are acceptable for proper operation of this embodiment in the context its intended application.

Further features and advantages of the present invention will become apparent to those of ordinary skill in the art upon reading of the following description, taken in conjunction with the appended drawings.

The following description is provided to gain a comprehensive understanding of the methods, apparatus and/or systems described herein. Various changes, modifications, and equivalents of the methods, apparatuses and/or systems described herein will suggest themselves to those of ordinary skill in the art. Description of well-known functions and structures may be omitted to enhance clarity and conciseness.

Although some features may be described with respect to individual exemplary embodiments, aspects need not be limited there to such that features from one or more exemplary embodiments may be combinable with other features from one or more exemplary embodiments.

### BRIEF DESCRIPTION OF THE DRAWINGS

FIGS. 1A, 1B, 1C and 1D (PRIOR ART) are, respectively, a perspective view, a top plan view, a bottom plan view and a front elevation view of an MDC-APC duplex optical-fiber connector.

FIG. 2 is a back-perspective view of an optical-fiber connector endface inspection microscope coupled to an adapter tip for imaging optical-fiber endfaces of an APC trans-duplex optical-fiber connector, in accordance with one embodiment.

FIG. 3 is a back-perspective view of the optical-fiber connector endface inspection microscope of FIG. 2, wherein optical-fiber connector and connector adapted are exploded from the optical-fiber connector endface inspection microscope.

FIG. 4A is a cross-sectional view of the optical-fiber connector endface inspection microscope of FIG. 2.

FIG. 4B is a top plan schematic of the optical configuration of the optical-fiber connector endface inspection microscope and adapter tip of FIG. 2.

FIG. 4C is a side elevation schematic of the optical configuration of the optical-fiber connector endface inspection microscope and adapter tip of FIG. 2.

FIG. 5 is a perspective view of an adapter tip in accordance with one embodiment.

FIG. 6A is bottom plan view, FIG. 6B is a left-side elevation view, FIG. 6C is a top plan view, FIG. 6D is a right-side elevation view, FIG. 6E is a front elevation view and FIG. 6F is a back elevation view of the adapter tip of FIG. 5.

FIG. 7 is an exploded perspective view of the adapter tip of FIG. 5.

FIG. 8A is a perspective view and FIG. 8B is a side elevation view of the optical prisms of the adapter tip of FIG. 5.

FIG. 9A is a top plan view, FIG. 9B is a left-side elevation view and FIG. 9C is across-sectional view along line B-B of the adapter tip of FIG. 5

FIG. 10A is cross-sectional view along line C-C, FIG. 10B is a top plan view, FIG. 10C is cross-sectional view along line D-D, FIG. 10D is a left-side elevation view and FIG. 10E is a cross-sectional view along line E-E of the adapter tip of FIG. 5 connected to a connected adapter and an APC trans-duplex optical-fiber connector.

FIG. 11A is detail cross-sectional view along line A-A, FIG. 11B is a cross-sectional view along line A-A and FIG. 11C is a top plan view of the adapter tip of FIG. 5 connected to a connected adapter and an APC trans-duplex optical-fiber connector.

FIG. 12A is detail cross-sectional view along line A-C, FIG. 12B is a cross-sectional view along line A-C and FIG. 12C is a top plan view of the adapter tip of FIG. 5 connected to a connected adapter and an APC trans-duplex optical-fiber connector.

FIG. 13 is a cross-sectional view of an adapter tip in accordance with another embodiment employing pairs of optical wedges.

FIG. 14 is a block diagram illustrating an example architecture of an optical-fiber connector endface inspection microscope device.

It will be noted that throughout the drawings, like features are identified by like reference numerals. In the following description, similar features in the drawings have been given similar reference numerals and, to not unduly encumber the figures, some elements may not be indicated on some figures if they were already identified in a preceding figure. It should be understood herein that elements of the drawings are not necessarily depicted to scale, since emphasis is placed upon clearly illustrating the elements and structures of the present embodiments. Some mechanical or other physical components may also be omitted in order to not encumber the figures.

### DETAILED DESCRIPTION

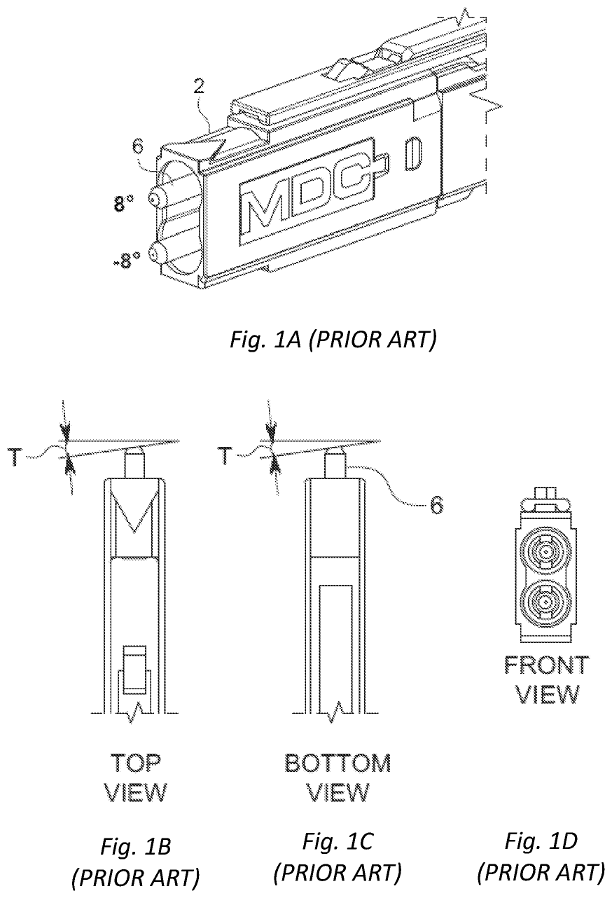

Now referring to the drawings, FIGS. 1A and 1B illustrate an MDC-APC connector. As shown, the MDC-APC connector is an APC trans-duplex connector duplex connector. It comprises two optical ferrules defining corresponding optical-fiber endfaces. Both optical fiber endfaces are angled-polished (APC) at 8 degrees, but in different directions such that they are not parallel to one another.

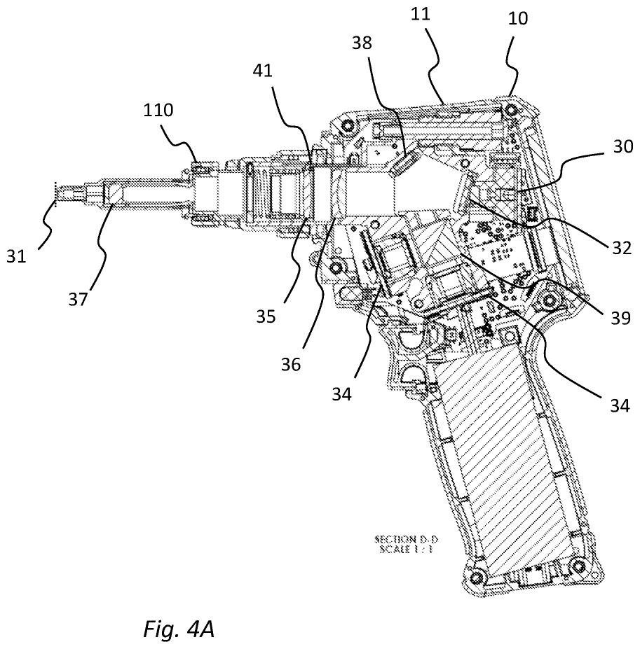

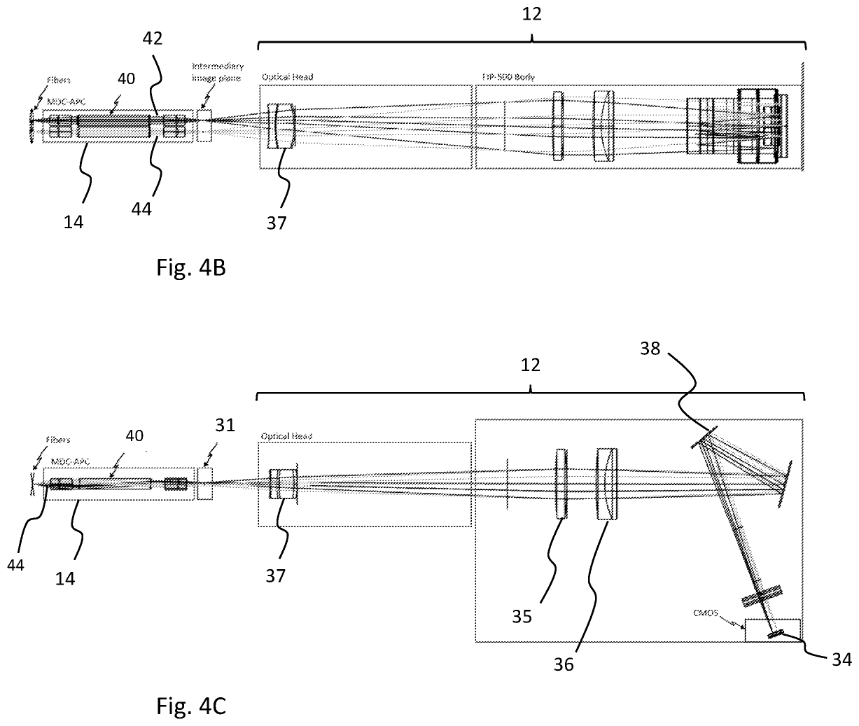

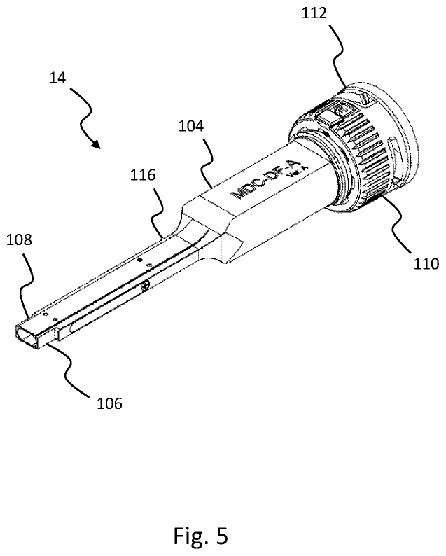

This configuration raises optical-fiber connector inspection issues that were not addressed before. Because the two optical-fiber endfaces of an APC trans-duplex connector are angled-polished (APC) in different directions (non-parallel), inspection of both endfaces with a single connection to the optical-fiber connector endface inspection microscope can be problematic, i.e., inspection light reflected on the two endfaces take diverging pathways (see FIGS. 4C, 11A and 12B). Without the herein-provided adapter tip, a single-fiber or multi-fiber inspection microscope cannot allow inspection of both optical-fiber endfaces at once.

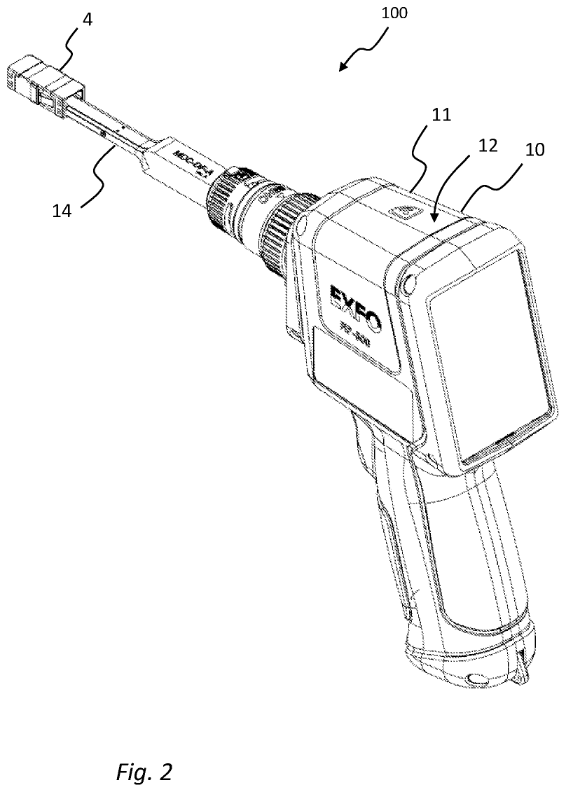

FIGS. 2, 3, 4A, 4B and 4C illustrate an optical-fiber connector endface inspection microscope system 100 for imaging the optical-fiber endfaces of an APC trans-duplex optical-fiber connector 2. In some applications, the optical-fiber connector 2 to be inspected using an optical-fiber connector endface inspection microscope system 100 is inserted in a connector adapter 4. As known in the art, connector adapters are used to interconnect two optical fibers terminated by optical-fiber connectors such as connector 2. In order for the endfaces of the optical fibers to be brought into close contact, optical-fiber connectors employ fiber-optic ferrules 6 (see FIG. 1A) in which the terminated portion of an optical fiber is inserted. The fiber-optic ferrule 6 and optical fiber assembly is polished at the termination, either perpendicularly to the optical fiber axis or at an 8-degree angle in the case of Angled-polished Physical Contact (APC) connectors, so as to form a ferrule endface enclosing, usually in its center, the optical-fiber endface.

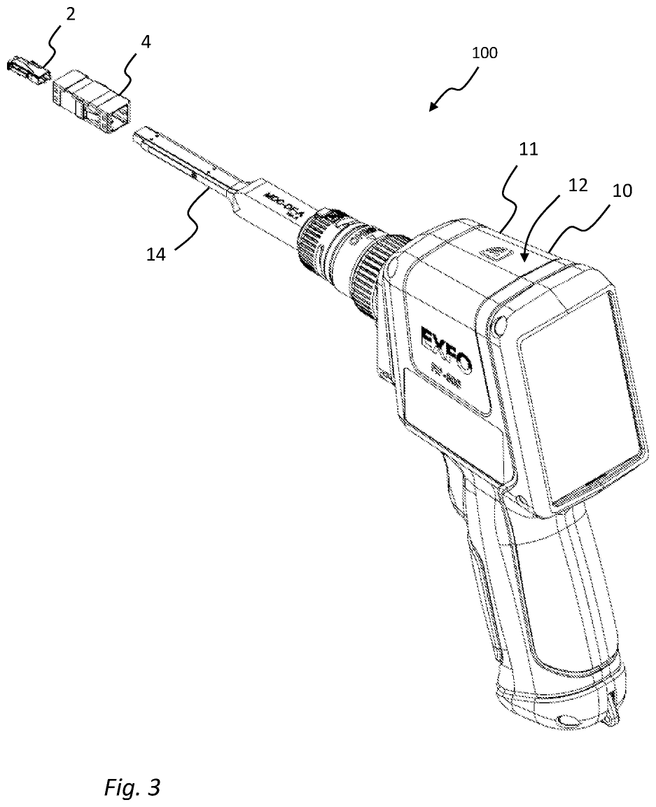

Referring to FIGS. 2 and 3, the optical-fiber inspection microscope system 100 comprises an inspection microscope device 10 comprising a main housing structure 11 enclosing an optical-fiber connector endface inspection microscope 12, and an interchangeable adapter tip 14. It will be understood that the configuration of FIGS. 2 and 3 illustrates one example embodiment of an optical-fiber connector endface inspection microscope system. It should be appreciated by those of ordinary skill in the art that various implementations of the inspection microscope device can be envisaged as known in the art and that the embodiment illustrated herein is no way meant to be limitative.

The inspection microscope device 10 is an inspection microscope device adapted to be employed with a variety of interchangeable adapter tips so as to allow inspection of various types of optical-fiber connectors directly or as inserted in an optical-fiber connector adapter 4. The adapter tip 14 and the inspection microscope device 10 together form an inspection microscope system 100.

The most common adapter tips employed for inspecting, e.g., FC/PC or FC/APC connectors are mostly mechanical adapters and therefore do not include any optical elements. Hence, the input lens of the inspection microscope 12 is referred to herein as the “objective lens” 37 (see FIGS. 4A and 4B).

The illustrated adapter tip 14 is suitable for imaging the optical-fiber endface of an APC trans-duplex optical-fiber connector 2 and is designed to interface the inspection microscope device 10 with an optical-fiber connector 2 that is inserted in a duplex connector adapter 4. That being said, in order to inspect male duplex optical-fiber connectors 2, one simply needs to connect a duplex connector adapter 4 to the duplex optical-fiber connector to be inspected. Although the embodiment illustrated herein is configured to interface with MDC-APC connectors, it should be understood that its mechanical and optical elements may be modified to interface with other formats of APC trans-duplex optical-fiber connectors and connector adapters.

Referring to FIGS. 4A, 4B and 4C, generally, an inspection microscope incorporates an imaging assembly comprising an illumination source arrangement 30, an illumination beam splitter 32, one or more image sensors 34 (two image sensors in the embodiment of FIG. 4A and a single one in that of FIG. 4C), imaging optics and an actuator 41. The illumination source arrangement 30 illuminates the connector endface to be inspected and which lies on an object plane 31. The illumination beam splitter 32 directs illumination light toward the connector endface. The image sensor(s) 34 captures at least one image of the endface to be inspected. The imaging optics comprises an objective lens system 35, 36, 37 (and optionally other lenses, mirrors (see, e.g., 38) and/or other optical components (e.g., beamsplitter 39)), for imaging the illuminated connector endface, on the image plane(s) coinciding with the image sensor(s) 34. The object plane 31 as defined herein coincides with the plane where the connector endface to be inspected (i.e., the object) should be positioned relative to the objective lens system (within the focusing range thereof) to be suitably imaged on the image sensor(s) 34. The optical path between the object plane and the image plane defines an imaging path of the inspection microscope 12, along which propagates the inspection light beam resulting from a reflection of illumination light on the connector endface, for optical magnification of the object (i.e., the connector endface) positioned on the object plane 31. In the case of the adapter tip 14, there are two optical/imaging paths, one for each optical-fiber endface of the duplex optical-fiber connector 2.

More specifically, the objective lens system of the embodiment of FIG. 4A comprises a focusing lens 35 for adjusting a focus of the objective lens system (here movable using the actuator 41) and some fixed lenses 36, 37. It will be understood that the objective lens system may further comprise other lenses or optical elements as required by the optical design, which lenses and optical elements can be either fixed relative to the microscope system or movable, e.g., held fixed with the focusing lens.

It is noted that in other embodiments, focus may be adjusted using a deformable focusing lens instead of a movable focusing lens. In such case, the focusing lens 35 may also remain fixed during focus adjustment.

In the embodiment of FIG. 4A, two image sensors 34 are disposed so as to capture images of respective regions over the connector endface (i.e., left and right regions of the connector endface). The light beam reflected on the inspected endface is split among the two image sensors 34 using the beamsplitter 39 and is split so as to produce an image of a left-side region of the connector endface on one image sensor 34 and an image of a right-side region on the other image sensor 34. This is achieved by adequately offsetting each image detectors relative to the center axis of the optical system. The two images may be stitched in processing to obtain a single image covering the whole region of interest over the connector endface. Such configuration can be useful, e.g., for multi-fiber connector inspection and may also be used for duplex connector inspection.

As shown in the embodiment of FIG. 4C, it is also possible to use a single image sensor 34 to cover the whole region of interest over the duplex connector endface, depending on the available technology and required image resolution.

In the case of duplex connectors such as that shown in FIG. 1A, the connector endface includes two ferrules 6, each defining an optical-fiber endface to be inspected. As known in the art, in order to properly image the optical-fiber endface, the light beam reflected from the endface (through reflection of the illumination light on the connector endface) should be appropriately collected by the inspection microscope objective lens 37. Because the two optical-fiber endfaces of an APC trans-duplex connector are angled-polished in different directions (non-parallel), inspection of both endfaces with a single connection to the optical-fiber connector endface inspection microscope can be problematic, i.e., inspection light reflected on the two endfaces take diverging pathways (see FIGS. 4C, 11A and 12A). Without the herein-provided adapter tip, a single-fiber or multi-fiber inspection microscope cannot allow inspection of both optical-fiber endfaces at once.

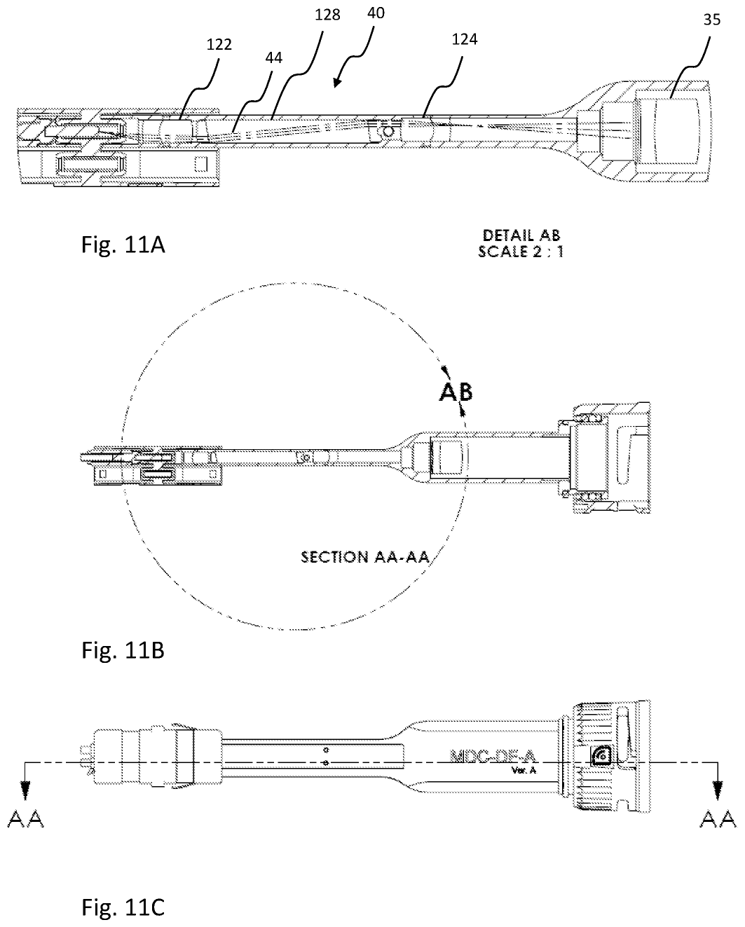

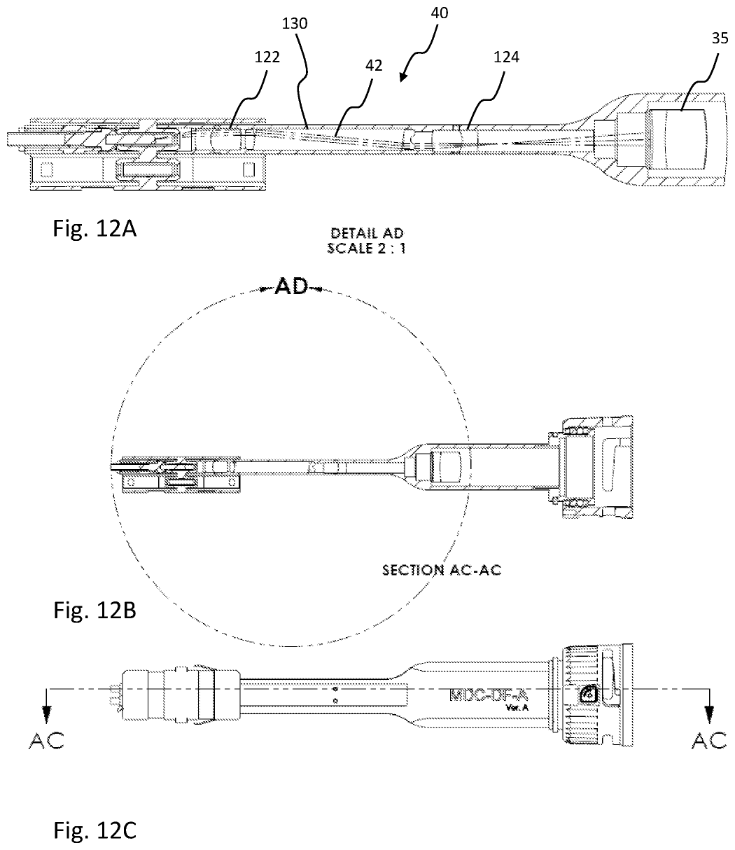

Referring to FIGS. 4A, 4B, 4C, for that reason, the microscope system 100 comprises an adapter tip 14 which comprises relay optics 40 configured to allow inspection of both endfaces at once. The adapter tip 14 defines two optical/imaging paths, i.e., one for each optical-fiber endface of the duplex optical-fiber connector 2. Each imaging path comprises at least one optical component (e.g., a parallelepiped-like optical prism) used to deviate inspection light beams 44 (better shown in FIGS. 11A and 12A) from each endface towards the optical axis of the objective lens (which is parallel to the optical fiber axis) and bring both inspection paths substantially parallel toward the objective lens 37 of the optical-fiber connector-endface inspection microscope 12 (while they would otherwise take diverging pathways) such that both endfaces may be imaged within the field of view of the inspection microscope 12.

It is noted that even though both endfaces can be imaged concurrently within the field of view of the inspection microscope, because of possible mechanical play and micro misalignments in both the duplex optical-fiber connector 2 and the adapter tip 14 as well as differences in optical path lengths within the inspection microscope 12, both enfaces may not be concurrently at focus on the image sensor(s). For that reason, two images may need to be captured with different focus adjustments of the objective lens system, i.e., one for each endface of the duplex connector 2. In one embodiment, a controller is used to control the actuator 41 and move the focusing lens 35 for adjusting a focus of the objective lens system. The controller is configured to adjust a focus of the objective lens system in a first position where one of the optical fiber endfaces is in focus on the image sensor and capture a first image and then adjust a focus of the objective lens system in a second position where the other one of the optical fiber endfaces is in focus on the image sensor and capture a second image (wherein the second position may be different from the first position). Depending on the configuration of the inspection microscope 12 (single or dual image sensor), both images may be captured using the same or distinct image sensors.

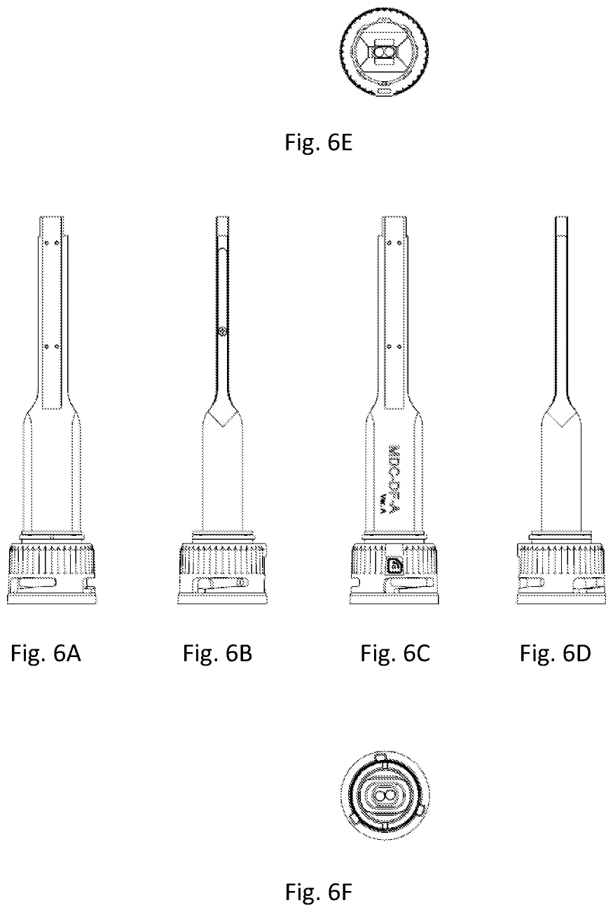

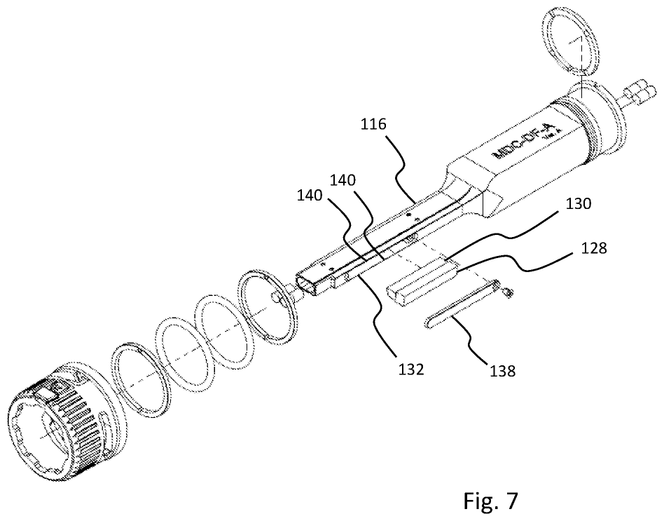

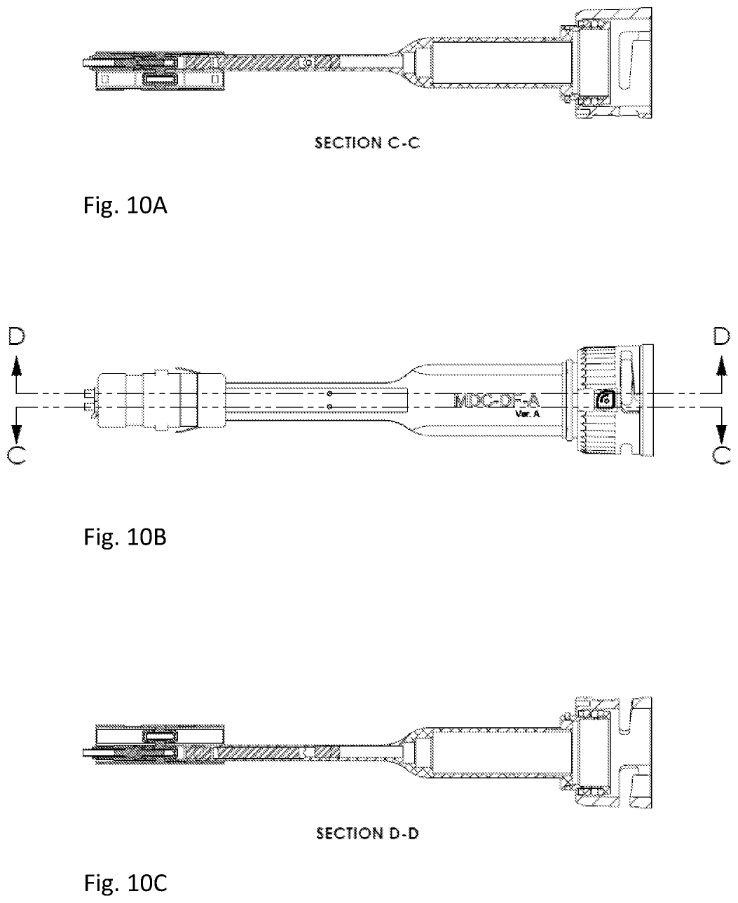

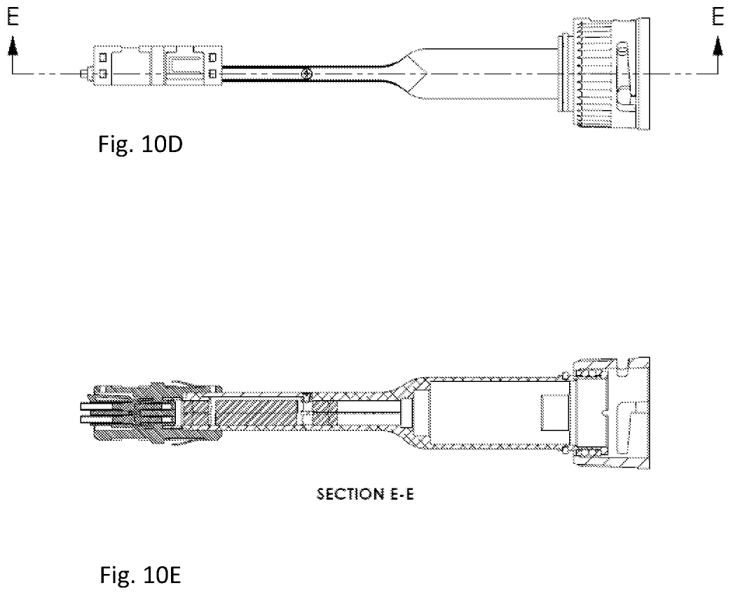

Referring to FIGS. 5-12, the adapter tip 14 comprises a housing 104 having a mating interface 106 on its proximal end 108 configured to mechanically engage with the connector adapter 4, a connection mechanism 110 on its distal end 112 to releasably attach to the housing structure 11 of the inspection microscope device 10 and a hollow light-relaying body 116 (better shown in FIG. 9C) between its proximal end 108 and its distal end 112 allowing light beams reflected from the optical fiber endfaces to propagate from the optical-fiber endfaces to the objective lens 36 of the inspection microscope 12.

The mating interface 106 has outer dimensions that are substantially complementary to inner dimensions of a connector adapter 4 so that it easily inserts into the connector adapter 4 in close proximity with the optical-fiber endfaces to be inspected, and this without direct contact with the optical-fiber endface. Alignment of adapter tip 14 with the optical-fiber connector 2 is at least partly achieved by the small mechanical play of the mating interface 106 within the connector adapter 4.

The adapter tip 14 may be made easily releasably connectable to the main housing structure 11 using a connection mechanism 110 such as a twist and lock mechanism (as shown) or a screw-threaded mechanism for example. The inspection microscope main housing structure 11 has a corresponding connection mechanism allowing easily releasable connection. Of course, other solid and releasable connection mechanisms such as a bayonet connector for example may be used instead.

As better seen in FIGS. 4B, 9C, 11A and 12A, the relay optics 40 defines two distinct optical paths, i.e., one for the light beam 42 reflected from one optical fiber endface (corresponding to the first ferrule) and the other for the light beam 44 reflected from the other optical fiber endface (corresponding to the second ferrule). Along each optical path, the relay optics 40 comprises a pair of collimating lenses 122, 124 (herein complex converging lenses) which focal points are designed to substantially collimate the light beam 42, 44 between the two lenses 122, 124 and reproduce the object lying on the object plane 31, on an intermediate image plane 126 for proper imaging using the inspection microscope 12.

The collimating lenses 122, 124 are used to elongate the adapter tip 14 relative to a nominal length dictated by the focal length of the objective lens system 35, 36, 37 and increase the distance between the object plane 31 and the objective lens 37, so as to allow insertion of additional optical components along the optical paths. It is however noted that other designs of the objective lens system (e.g., longer focal length) and/or adapter tip 14 may be envisaged, which designs may not necessitate such collimating lenses 122, 124.

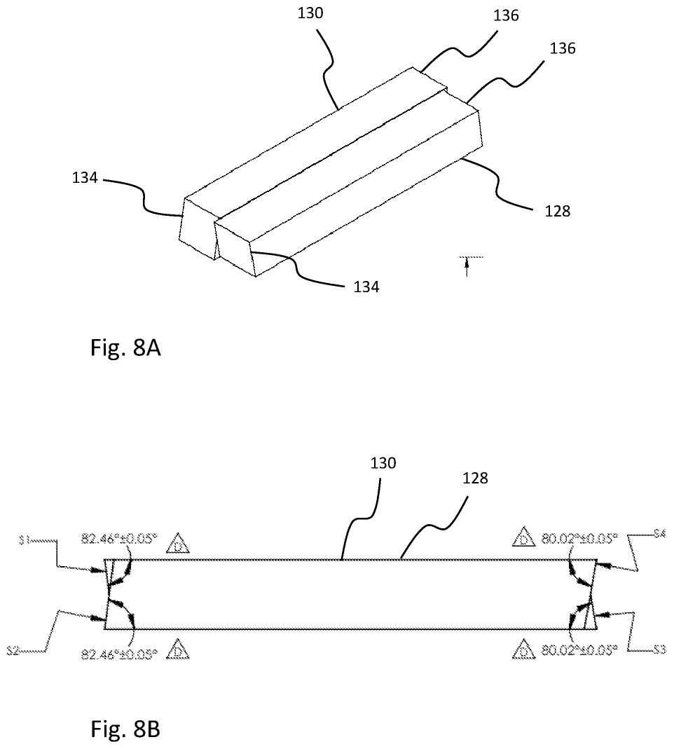

Referring to FIGS. 7-12, the relay optics 40 further comprises two optical prisms 128, 130 each disposed along one of an imaging path, between two collimating lenses 122, 124. The optical prisms 128, 130 define the two imaging paths 42, 44 for respectively imaging the two optical-fiber endfaces. As shown in FIGS. 11A and 12A, when reflected on its respective endface, the light beam takes a direction that is approximatively normal to the endface, i.e., about ±8 degrees relative to the optical fiber axis. The light beam reaches and exits the collimating lens 122 close to one of its edge (and also close to the tip internal surface 140) and then reaches the optical prism 128 or 130 also close to one of its edge. The optical prisms 128, 130 are designed to deviate the corresponding light beam 42, 44 towards the optical axis of the objective lens (which is parallel to the optical fiber axis) and bring both inspection paths substantially parallel toward the objective lens 35 of the optical-fiber connector-endface inspection microscope device, while they would otherwise take diverging pathways. At the exit of the optical prism 128 or 130, the light beam reaches and exits the collimating lens 124 close to one of its edge, which collimating lens 124 converges the light beam toward the objective lens of the inspection microscope. The optical prisms 128, 130 act to bring both light beams to reach the objective lens of the inspection microscope such that both endfaces may be imaged within the field of view of the inspection microscope.

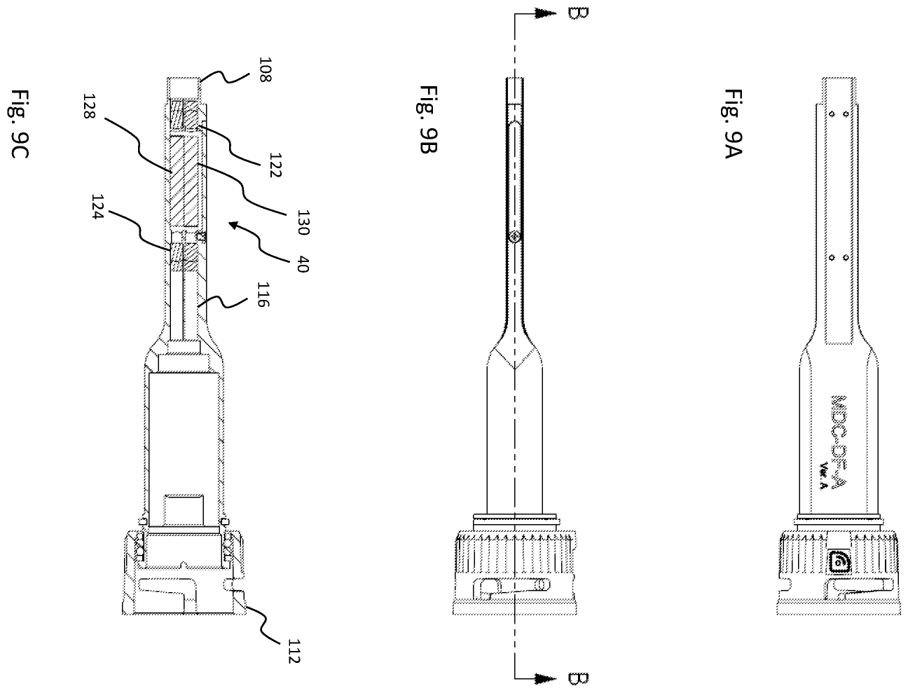

In some embodiments, the optical prisms may be shaped as parallelepipeds. However, as shown in FIG. 8B, the optical prisms 128, 130 of the illustrated embodiment are not exact parallelepipeds. Each optical prism 128, 130 comprises two pairs of parallel longitudinal surfaces and two end surfaces 134, 136 which are not exactly parallel. The two end surfaces 134, 136 are both tilted relative to an optical axis the corresponding light beam and act as a first refracting plane surface 134 and second refracting plane surface 136 so as to deviate the corresponding light beam towards the optical axis of the objective lens (which is parallel to the optical fiber axis). The first refracting plane surface 134 forms an angle of about 82.46 degrees relative to the optical fiber axis and the second refracting plane surface 136 forms an angle of about 80.02 degrees relative to the optical fiber axis. Those angles are designed to bring the light beams substantially parallel to the optical fiber axis when exiting the relay optics and optimize the illumination of the optical fiber endface as well as the general quality of the image produced on the image sensor(s). These optical prisms are also quite simple to manufacture and unexpensive.

The light beam which is reflected on the angled-polished optical fiber endface deviates from the optical fiber axis at an angle of 8 degrees. When the light beam reaches the first refracting plane surface 134, it is refracted so it deviates toward the optical fiber axis. When it reaches the second refracting plane surface 136, it is refracted again so it exits the relay optics in a direction that is substantially parallel to the optical fiber axis.

By using a parallelepiped-like optical prism 128, 130, both collimating lenses 122, 124 can be placed very close to the optical fiber axis, which keeps the design very compact in the transverse direction.

The refraction at the interface of the parallelepiped is what offsets the light beams to allow the intermediary image to form within the field of view of the inspection microscope probe. Without the optical prisms 130, the second collimating lens 124 would be too much offset from the optical-fiber axis for the intermediary image to form within the field of view of the inspection microscope probe.

The relay optics defines two optical paths, i.e., one for each endface to be inspected. The left path is the same as the right except that it is flipped 180° with respect to the center axis of the objective lens 35.

Moreover, in some embodiments, the two optical prisms 128, 130 may be joined to one another (e.g., using glue) before being installed in the body 116 of the adapter tip 14, so even fewer optical pieces need to be installed and aligned during mechanical assembly. This can save valuable assembly time. Furthermore, in other embodiments, the two optical prisms 128, 130 may be manufactured as a single piece of glass comprising four refracting plane surfaces 134, 136.

Referring to FIG. 7, the hollow body 116 of the adapter tip 14 may be machined so as to define internal surfaces 140 which may serve to align the optical prisms 128, 130 within the body 116, the optical prisms 128, 130 being jointly affixed in the body 116 by inserting and affixing the optical prisms 128, 130 in the body 116 such that two longitudinal surfaces of the optical prisms 128, 130 abut internal surfaces 140 machined in the body 116. The optical prisms 128, 130 can be installed by a simple drop and fix process which do not require any optical alignment, making the adapter tip 14 very easy to assemble. A cover plate 138 covers the cavity to protect the optical components for the surrounding environment.

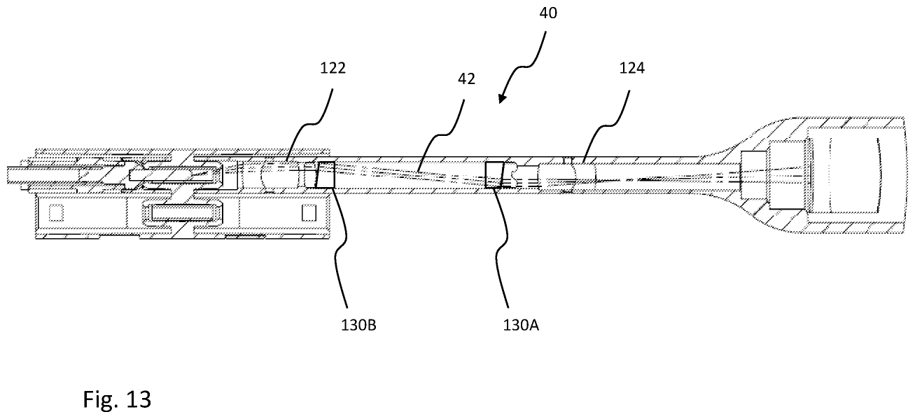

Referring to FIG. 13, it is noted that although the embodiments illustrated herein employ parallelepiped-like optical prisms 128, 130, a similar result may be obtained by replacing each parallelepiped-like optical prism with a pair of optical wedges 130A, 130B (also known in the art as wedge prisms) separated by an air gap. More specifically, the relay optics may comprise a first optical wedge and a second optical wedge along each imaging path, wherein one surface of the first optical wedge defines a first refracting plane surface and one surface of the second optical wedge defines the second refracting plane surface along each imaging path.

It is however noted that, compared to small wedges, the use of parallelepiped-like optical prism simplifies the mechanical design, and the larger size of the parallelepiped facilitates its assembly (e.g., small parts tend to tilt more than large parts when assembled).

### Example of Inspection Microscope Device Architecture

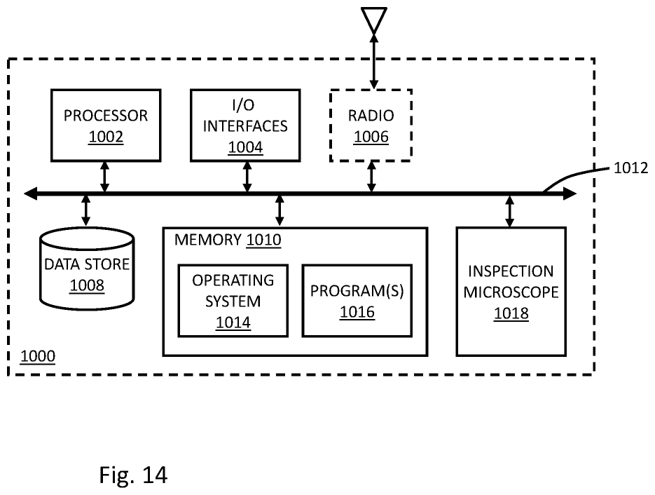

FIG. 14 is a block diagram of an inspection microscope device 1000 which may embody the inspection microscope device 10 of FIGS. 2, 3 and 4A. The inspection microscope device 1000 may comprise a digital device that, in terms of hardware architecture, generally includes a processor 1002, input/output (I/O) interfaces 1004, an optional radio 1006, a data store 1008, a memory 1010, as well as an optical test device including an inspection microscope 1018. It should be appreciated by those of ordinary skill in the art that FIG. 14 depicts the inspection microscope device 1000 in a simplified manner, and a practical embodiment may include additional components and suitably configured processing logic to support known or conventional operating features that are not described in detail herein. A local interface 1012 interconnects the major components. The local interface 1012 can be, for example, but not limited to, one or more buses or other wired or wireless connections, as is known in the art. The local interface 1012 can have additional elements, which are omitted for simplicity, such as controllers, buffers (caches), drivers, repeaters, and receivers, among many others, to enable communications. Further, the local interface 1012 may include address, control, and/or data connections to enable appropriate communications among the aforementioned components.

The processor 1002 is a hardware device for executing software instructions. The processor 1002 may comprise one or more processors, including central processing units (CPU), auxiliary processor(s) or generally any device for executing software instructions. When the inspection microscope device 1000 is in operation, the processor 1002 is configured to execute software stored within the memory 1010, to communicate data to and from the memory 1010, and to generally control operations of the inspection microscope device 1000 pursuant to the software instructions. The processor 1002 may implement a controller used to control the operation of the image detectors and the illumination sources of the inspection microscope 1018, e.g., to capture images from each image detector in sequence while also activating the illumination sources in sequence. The controller may further be used to control the actuator used to move the focusing lens 35 for adjusting a focus of the objective lens system.

In an embodiment, the processor 1002 may include an optimized mobile processor such as optimized for power consumption and mobile applications. The I/O interfaces 1004 can be used to receive user input from and/or for providing system output. User input can be provided via, for example, a keypad, a touch screen, a scroll ball, a scroll bar, buttons, barcode scanner, and the like. System output can be provided via a display device such as a liquid crystal display (LCD), touch screen, and the like, via one or more LEDs or a set of LEDs, or via one or more buzzer or beepers, etc. The I/O interfaces 1004 can be used to display a graphical user interface (GUI) that enables a user to interact with the inspection microscope device 1000 and/or output at least one of the values derived by the inspection microscope analyzing software.

The radio 1006, if included, may enable wireless communication to an external access device or network. Any number of suitable wireless data communication protocols, techniques, or methodologies can be supported by the radio 1006, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); NarrowBand Internet of Things (NB-IoT); Long Term Evolution Machine Type Communication (LTE-M); magnetic induction; satellite data communication protocols; and any other protocols for wireless communication. The data store 1008 may be used to store data, such as inspection microscope images. The data store 1008 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 1008 may incorporate electronic, magnetic, optical, and/or other types of storage media.

The memory 1010 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 1010 may incorporate electronic, magnetic, optical, and/or other types of storage media. Note that the memory 1010 may have a distributed architecture, where various components are situated remotely from one another, but can be accessed by the processor 1002. The software in memory 1010 can include one or more computer programs, each of which includes an ordered listing of executable instructions for implementing logical functions. In the example of FIG. 14, the software in the memory 1010 includes a suitable operating system (O/S) 1014 and computer programs 1016. The operating system 1014 essentially controls the execution of other computer programs and provides scheduling, input-output control, file and data management, memory management, and communication control and related services. The program(s) 1016 may include various applications, add-ons, etc. configured to provide end-user functionality with the inspection microscope device 1000. For example, example programs 1016 may include a web browser to connect with a server for transferring inspection result data files, a dedicated inspection microscope application configured to control inspection microscope measurements by the inspection microscope 1018, set image acquisition parameters, analyze connector endface images obtained by the inspection microscope 1018 and display a GUI related to the inspection microscope device 1000.

It is noted that, in some embodiments, the I/O interfaces 1004 may be provided via a physically distinct mobile device (not shown), such as a handheld computer, a smartphone, a tablet computer, a laptop computer, a wearable computer or the like, e.g., communicatively coupled to the inspection microscope device 1000 via the radio 1006. In such cases, at least some of the programs 1016 may be located in a memory of such a mobile device, for execution by a processor of the physically distinct device. The mobile may then also include a radio and be used to transfer measurement data files toward a remote test application residing, e.g., on a server.

The embodiments described above are intended to be exemplary only and one skilled in the art will recognize that numerous modifications can be made to these embodiments without departing from the scope of the invention. The scope of the invention is therefore intended to be limited solely by the appended claims.

1. An adapter tip to be employed with an optical-fiber connector endface inspection microscope for imaging two non-parallel APC optical-fiber endfaces of a duplex optical-fiber connector, the adapter tip comprising:
a housing having:
a mating interface on one end, configured to mechanically engage with the duplex optical-fiber connector for inspecting the optical-fiber endfaces;
a connection mechanism on the other end, to releasably attach to the inspection microscope; and
a hollow body extending between the one end and the other end and allowing light beams reflected from the optical-fiber endfaces to propagate to an objective lens of the inspection microscope; and
relay optics disposed in said hollow body of said housing and defining two imaging paths for respectively imaging said two optical-fiber endfaces, said relay optics comprising a first refracting plane surface and a second refracting plane surface along each of said imaging paths, wherein said first refracting plane surface and said second refracting plane surface are both tilted relative to the corresponding light beam so as to deviate said corresponding light beam towards an optical axis of the objective lens, such that both light beams reach the objective lens of the inspection microscope and both endfaces may be imaged within a field of view of the inspection microscope.

2. The adapter tip as claimed in claim 1, wherein said relay optics comprise two optical prisms, each along one of said imaging paths, each said optical prism defining a first refracting plane surface and a second refracting plane surface.

3. The adapter tip as claimed in claim 2, wherein said optical prisms are joint to one another.

4. The adapter tip as claimed in claim 3, wherein said optical prisms comprises longitudinal surfaces and wherein said optical prisms are jointly affixed in said hollow body by inserting and affixing said optical prisms in said hollow body such that two longitudinal surfaces abut internal surfaces machined in said hollow body.

5. The adapter tip as claimed in claim 1, wherein said relay optics comprise a first optical wedge and a second optical wedge along each one of said imaging paths, wherein one surface of said first optical wedge defines said first refracting plane surface and one surface of said second optical wedge defines said second refracting plane surface along each of said imaging paths.

6. The adapter tip as claimed in claim 1, wherein said relay optics comprises a pair of collimating lenses along each of said imaging paths, said first refracting plane surface and said second refracting plane surface being disposed in-between said collimating lenses.

7. An optical-fiber connector endface inspection microscope system for imaging two non-parallel APC optical-fiber endfaces of a duplex optical-fiber connector, the inspection microscope system comprising:
an optical-fiber connector endface inspection microscope device having an objective lens defining a field of view of the inspection microscope device; and
an adapter tip connectable to the optical-fiber connector endface inspection microscope device and comprising:
a housing having:
a mating interface on one end, configured to mechanically engage with the duplex optical-fiber connector for inspecting the optical-fiber endfaces;
a connection mechanism on the other end, to releasably attach to the inspection microscope; and
a hollow body extending between the one end and the other end and allowing light beams reflected from the optical-fiber endfaces to propagate to the objective lens of the inspection microscope; and
relay optics disposed in said hollow body of said housing and defining two imaging paths for respectively imaging said two optical-fiber endfaces, said relay optics comprising a first refracting plane surface and a second refracting plane surface along each of said imaging paths, wherein said first refracting plane surface and said second refracting plane surface are both tilted relative to the corresponding light beam so as to deviate said corresponding light beam towards an optical axis of the objective lens, such that both light beams reach the objective lens of the inspection microscope and both endfaces may be imaged within a field of view of the inspection microscope.

8. The optical-fiber connector endface inspection microscope system as claimed in claim 7,
wherein the optical-fiber connector endface inspection microscope device comprises at least one image sensor for capturing images of the endfaces to be inspected, and an objective lens system comprising a focusing lens for adjusting a focus of the objective lens system on the at least one image sensor and a controller; and
wherein the controller is configured to:
adjust a focus of the objective lens system in a first position where one of the optical fiber endfaces is in focus on said at least one image sensor and capture a first image; and
adjust a focus of the objective lens system in a second position where the other one of the optical fiber endfaces is in focus on said at least one image sensor and capture a second image, wherein the second position is different from the first position.

9. The optical-fiber connector endface inspection microscope system of claim 7, wherein said optical-fiber connector endface inspection microscope device comprises a first image sensor and a second image sensor, disposed so as to capture images of respective regions over the optical-fiber endface.

10. The optical-fiber connector endface inspection microscope system as claimed in claim 7, wherein said relay optics comprise two optical prisms, each along one of said imaging paths, each said optical prism defining a first refracting plane surface and a second refracting plane surface.

11. The optical-fiber connector endface inspection microscope system as claimed in claim 10, wherein said optical prisms are joint to one another.

12. The optical-fiber connector endface inspection microscope system as claimed in claim 11, wherein said optical prisms comprises longitudinal surfaces and wherein said optical prisms are jointly affixed in said housing by inserting and affixing said optical prisms in said housing such that said longitudinal surfaces abut internal surfaces machined in said housing.

13. The optical-fiber connector endface inspection microscope system as claimed in claim 7, wherein said relay optics comprise a first optical wedge and a second optical wedge along each one of said imaging paths, wherein one surface of said first optical wedge defines said first refracting plane surface and one surface of said second optical wedge defines said second refracting plane surface along each of said imaging paths.

14. The optical-fiber connector endface inspection microscope system as claimed in claim 7, wherein said relay optics comprises a pair of collimating lenses along each of said imaging paths, said first refracting plane surface and said second refracting plane surface being disposed in-between said collimating lenses.
